(19) United States
(12) Patent Application Publication
(10) Pub. No.: US 2008/0060994 A1
(43) Pub. Date: Mar. 13, 2008

(54) Oil filter

(75) Inventor: Kenji Yano, Hamamatsu-shi (JP)

Correspondence Address: YOUNG & THOMPSON, 745 SOUTH 23RD STREET, 2ND FLOOR, ARLINGTON, VA, 22202, US

(73) Assignee: TOYO ROKI SEIZO KABUSHIKI KAISHA, HAMAMATSU (JP)

(21) Appl. No.: 11/896,381

(22) Filed: Aug. 31, 2007

(30) Foreign Application Priority Data
Sep. 13, 2006 (JP) 2006-247689

(51) Int. Cl. B01D 27/10; B01D 27/08

(52) U.S. Cl. 210/442

(57) ABSTRACT

The oil filter includes a base having an inlet port, an outlet port, and an oil channel communicating with the outlet port. A removable cap is provided to the base, and forms a filter case therewith. A tubular filter element is contained within the filter case. The oil channel coincides with the filter element in axis and extends in an axial direction of the filter case. An inner tube is located in the filter element; and an inner-tube extension fitted thereto movable in the axial direction of the filter case is located on a side of the outlet port. The base includes a holding portion having a joint portion, having the inner tube and the inner-tube extension joined each other, fitted therein. The holding portion includes a clearance portion allowing the inner-tube extension to separate from the inner tube under hydraulic pressure.

This application is based upon and claims the benefit of priority from Japanese Patent Application No. 2006-247689 filed on Sep. 13, 2006; the entire contents of which are incorporated herein by reference.

### BACKGROUND OF THE INVENTION

The invention relates to an oil filter used in an internal combustion engine of an automobile.

An existing oil filter of this type includes a base containing, for example, a filter element. The filter element includes a member located inside. The member is formed integrally with an inner-tube extension to an inner tube, coinciding with the filter element in axial direction.

As one example, the oil filter is configured so that the upper end of the inner-tube extension is engaged with the stepped portion of an oil channel formed in the filter element.

As another example, the oil filter is configured so that the lower end of a joint portion having the inner tube and the inner-tube extension joined each other is positioned with a clearance formed between the lower end and the stepped portion. The lower end of the inner-tube extension tightly contacts the lower end of the oil channel using an O-ring, thereby cutting off communication between the oil channel and a drain channel.

In the former oil filter, the inner tube and the inner-tube extension are positioned relative to each other by abutting, against the stepped portion, the lower end of the joint portion having the inner tube and the inner-tube extension joined each other. The inner tube and the inner-tube extension are fitted to a cap using urging means. The inner tube and the inner-tube extension are inserted in the filter element and the cap is fitted to the base. In this manner, the inner tube is fitted in the base with it being urged downward. Therefore, when the cap is fitted to the base, the lower end of the joint portion having the inner tube and the inner-tube extension joined each other abuts against the stepped portion. A load is imposed on the joint portion, thereby deforming or buckling the inner tube.

In an operation performed by the oil filter (described later), when an internal pressure of the oil filter rises, the inner-tube extension joined to the inner tube is pulled toward the drain channel. This operation imposes a heavy load on the engagement portion of the inner-tube extension engaged with the stepped portion. Therefore, the engagement portion is required to have sufficient strength. To form the member thicker to give sufficient strength to the engagement portion, the oil filter is made larger in size as a whole.

### SUMMARY OF THE INVENTION

The invention is directed to an oil filer having a simple structure securely reducing a load imposed on the inner tube or the inner-tube extension during assembly of the oil filter and following use of the oil filter after the assembly.

The invention is also directed to an oil filter without an excessive load to be imposed on the inner tube or the inner-tube extension.

The feature of the invention provides the following oil filter. The oil filter includes a base having an inlet port, an outlet port, and an oil channel communicating with the outlet port. The oil filter includes a cap removably provided to the base, forming a filter case with the base. The oil filter includes a tubular filter element contained within the filter case. The oil channel coincides with the filter element in axis and extends in an axial direction of the filter case. The oil filter includes an inner tube located in the filter element; and an inner-tube extension fitted to the inner tube, being movable in the axial direction of the filter case and being located on a side of the outlet port of the oil channel. The base includes a holding portion having a joint portion, having the inner tube and the inner-tube extension joined each other, fitted therein and holding the joint portion. The holding portion includes a clearance portion allowing the inner-tube extension to move in a direction of separating from the inner tube under a hydraulic pressure.

The joint portion includes a sliding portion extending from one of the inner tube and the inner-tube extension to the other one of the inner tube and the inner-tube extension in the axial direction. The joint portion includes a ring portion formed to the other one of the inner tube and the inner-tube extension and fitted in the sliding portion. Both ends of the sliding member in the axial direction include stoppers to abut against the ring portion for restricting movement of the sliding portion.

The sliding portion is elastically deformable. The distal end of the sliding portion is displaceable radially of the ring portion relative to the proximal end of the sliding portion. The displacement of the distal end of the sliding member allows the inner tube and the inner-tube extension to be removed from each other.

According to the invention, the inner tube and the inner-tube extension located in the filter element are movably positioned with a predetermined clearance, being axially movable relative to each other. This structure prevents deformation and bucking caused by compression of the inner tube during joining of the inner tube and inner-tube extension. Thus, this simple structure securely reduces a load imposed on the inner tube during assembling the oil filter.

During introducing an oil into the base, if the inner-tube extension is pulled toward the outlet port, the inner-tube extension is not subject to a load due to being movable of the inner-tube extension relative to the inner tube and positioning of the joint portion of the inner tube and the inner-tube extension with a predetermined clearance. Thus, this simple structure securely reduces a load, caused by using the oil filter, on an engagement portion.

### BRIEF DESCRIPTION OF THE ACCOMPANYING DRAWINGS

FIG. 1 is a schematic diagram illustrating a structure of an oil filter according to an embodiment of the invention;

FIG. 2 is an enlarged view of a part A illustrated in FIG. 1;

FIG. 3A is an explanatory diagram of an operation performed by the oil filter during stopping an engine; and

FIG. 3B is an explanatory diagram of the operation performed by the oil filter after the engine is started.

### DETAILED DESCRIPTION OF THE PREFERRED EMBODIMENTS

Preferred embodiments of the invention will be described below with reference to the accompanying drawings. An oil filter (described later) is an embodiment adapted to an oil filter of an automobile engine.

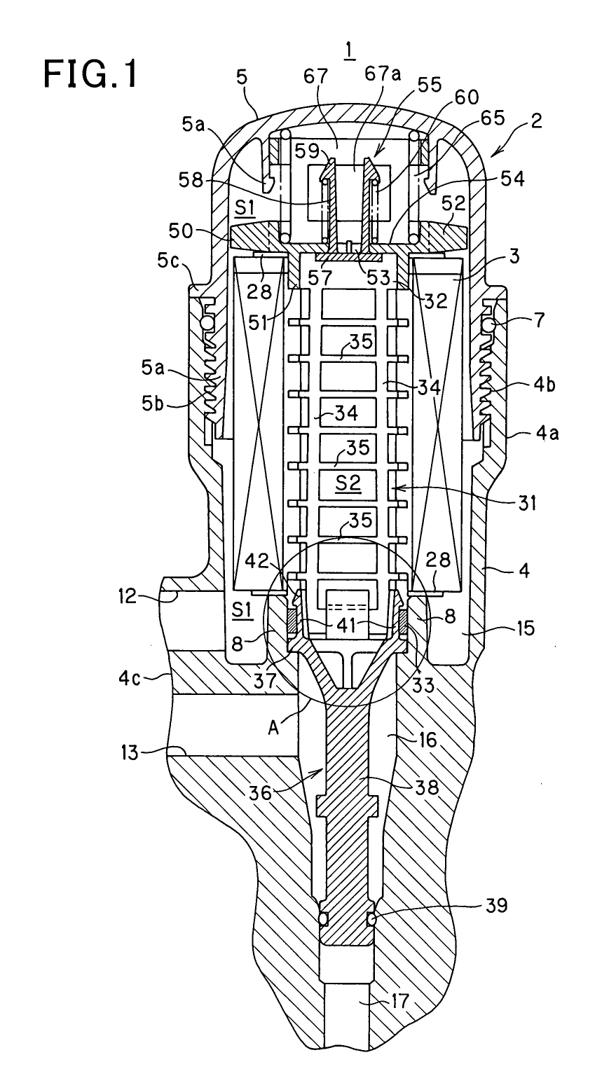

With reference to FIG. 1, an oil filter 1 includes a filter case 2 and a filter element 3 contained in the filter case 2. The filter case 2 is combined with a base 4 and a cap 5 into a hermetic container.

The base 4 includes a cylinder (tubular portion) 4a. The cylinder 4a includes a female screw 4b formed in the inner circumference and a male screw 5b formed on the end of a fitting portion 5a of the cap 5. The female screw 4b is screwed with the male screw 5b, thus connecting the cap 5 and the base 4 to each other. The cap 5 includes an O-ring 7 serving as seal means fitted to the outer circumference of the fitting portion 5a. The O-ring 7 tightly contacts the inner circumference of the cylinder 4a, thereby sealing the joint portion of the cap 5 and the base 4. The cap 5 has, between the top and the bottom thereof, a flange 5c abutting against the end surface of the cylinder 4a, thereby positioning the cap 5 in the axial direction of the cylinder 4a.

The base 4 defines an inlet port 12 and an outlet port 13 each having one end opened to a mounting surface 4c and the other end extending in a direction orthogonal to the axis of the cylinder 4a. When the base 4 is connected to, for example, the engine block of a vehicle, the mounting surface 4c tightly contacts the connected surface of the engine block. The inlet port 12 is connected to a discharge port for discharging oil from the engine. The outlet port 13 is connected to a feeding port led to a lubrication position of the engine.

The base 4 includes a fitting tube 8 inside thereof. The fitting tube 8 is positioned coaxially with the cylinder 4a. The fitting tube 8 includes an oil-introduction channel 15 located on the outer circumference and communicating with the inlet port 12. Meanwhile, an oil-feeder channel 16 functioning as an oil channel is formed below the fitting tube 8. The oil-feeder channel 16 communicates with the outlet port 13 and linearly extends downward, coinciding with the cylinder 4a in axis. The interior of the fitting tube 8 is slightly larger in inner opening diameter than the oil-feeder channel 16. The interior of the fitting tube 8 communicates with the oil-feeder channel 16, with a stepped portion 9 placed therebetween. The oil-introduction channel 15 is formed in the base 4 as an annular groove surrounding the oil-feeder channel 16. The oil-feeder channel 16 functions as the oil channel. The fitting tube 8 functions as a holding portion.

The oil-feeder channel 16 includes a drain channel 17 formed below the oil-feeder channel 16, coinciding with the oil-feeder channel 16 in axial direction, and extending in the axial direction of the cylinder 4a. The drain channel 17 communicates with the oil-feeder channel 16 and discharges the oil inside the filter case 2 to the outside of the oil filter 1. The drain channel 17 communicates with an oil pan of the engine.

The filter element 3 contained in the filter case 2 is formed into a generally tubular shape as a whole by folding a filtering member of a paper filter into continuous peaks and troughs so that the peaks and the troughs are alternately aligned circumferentially. Both axial ends of the filter element 3 are bonded to a seal plate 28 using, for example, an adhesive agent. The seal plate 28 is made of a material, e.g., a paper filter or an unwoven fabric, having a filtering function similarly to the filtering member. The filter element 3 is positioned coinciding with the cylinder 4a in axis.

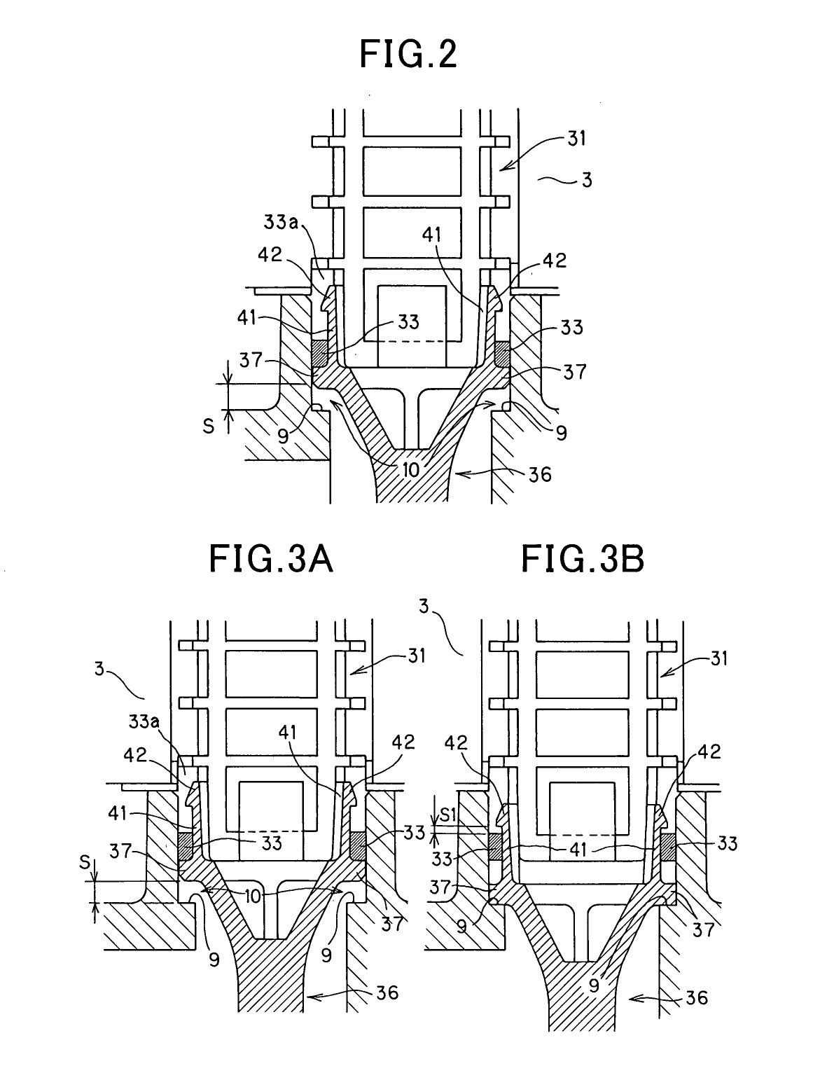

The filter element 3 includes an inner tube 31 fitted to the inner circumference of the filter element 3. The inner tube 31 includes an inner-tube extension 36 joined to the lower end of the inner tube 31. The inner-tube extension 36 is movable in the axial direction of the cylinder 4a with respect to the inner tube 31. The upper end of the inner-tube extension 36 is engaged with the stepped portion 9. The lower portion of the inner-tube extension 36 is inserted in the oil-feeder channel 16. The joint portion having the inner tube 31 and the inner-tube extension 36 joined each other is fitted in the fitting tube 8 for holding. As shown in FIG. 2, the fitting tube 8 includes a clearance portion 10. The clearance portion 10 allows the lower end of the joint portion, having the inner tube 31 and the inner-tube extension 36 joined each other, to be positioned with predetermined a clearance S formed between the joint portion and the stepped portion 9. The clearance portion 10 allows the inner-tube extension 36 to move downward with respect to the inner tube 31. By doing so, when the engagement portion 37 of the inner-tube extension 36 abuts against the stepped portion 9, load is not imposed on the engagement portion 37. The inner tube 31 and the inner-tube extension 36 are molded components made of a resin.

The inner tube 31 includes a pair of tubes 32 and 33 arranged on the both ends, respectively. The inner tube 31 includes, for example, four longitudinal ribs 34 extending in the axial direction to connect the tubes 32 and 33 to each other. The inner tube 31 includes ring-shaped transverse ribs 35 arranged at substantially equal intervals between the tubes 32 and 33.

The inner-tube extension 36 includes the engagement portion 37 arranged on the outer circumference of the upper end of the inner-tube extension 36 and engaged with the stepped portion 9. The inner-tube extension 36 includes a spindle 38 extending in the axial direction of the lower cylinder 4a. The spindle 38 includes an O-ring 39 serving as a seal member fitted to the outer circumference of the lower end of the spindle 38. The O-ring 39 tightly contacts the inner circumference of the lower end of the oil-feeder channel 16.

Normally, the oil-feeder channel 16 does not communicate with the drain channel 17 because the O-ring 39 tightly contacts the inner circumference of the lower end of the oil-feeder channel 16. On the other hand, during replacement of the filter element 3 with a new filter element 3, the inner-tube extension 36 is pulled out upward. Therefore, the oil-feeder channel 16 communicates with the drain channel 17. At the time of communication therebetween, the oil contained in the filter case 2 is returned to the oil pan via the drain channel 17.

The upper end of the inner-tube extension 36 includes a sliding member 41 extending upward along the axis of the cylinder 4a. The sliding member 41 slides on the inner circumference of the tube 33 provided on the lower end of the inner tube 31. The sliding member 41 has a distal end with a pawl 42. The pawl 42 is arranged in a groove 33a formed above the tube 33 provided on the lower end of the inner tube 31. The pawl 42 is engaged with the upper end of the tube 33 for assembly, thereby preventing both the pawl 42 and the tube 33 from coming off from each other in the axial direction of the cylinder 4a.

The upper end of the inner-tube extension 36 is formed in a circular shape. The sliding member 41 is arranged on the circumference of the circular upper end of the inner-tube extension 36. The inner circumferential surface of the tube 33 functioning as a ring portion according to the embodiment of the invention is fitted in the outer circumference of the sliding member 41. The sliding member 41 functions as a sliding portion. The tube 33 functions as a ring portion.

The tube 33 is movably held between the lower end of the sliding member 41, i.e., the upper end of the engagement portion 37 of the inner-tube extension 36 and the pawl 42 on the upper end of the sliding member 41 for restricting movement of the tube 33. Likewise, the movement of the inner-tube extension 36 is restricted. The pawl 42 and the engagement portion 37 act as stoppers restricting movement between the inner tube 31 and the inner-tube extension 36.

The inner tube 31 and the inner-tube extension 36 are movable in the axial direction of the cylinder 4a by mutual sliding of the tube 33 provided on the lower end of the inner tube 31 and the outer circumferential surface of the sliding member 41 of the inner-tube extension 36.

The sliding member 41 is made of an elastically deformable material. The distal end of the sliding member 41 is deformed in the radial direction of the tube 33 with respect to the proximal end of the sliding member 41. The pawl 42 on the distal end of the sliding member 41 is elastically deformed and arranged on the groove 33a above the tube 33. The pawl 42 is engaged with the upper end of the tube 33, thereby allowing the inner tube 31 and the inner-tube extension 36 to be detachable and attachable. This structure allows the inner-tube extension 36 to be joined to the inner tube 31 with one touch, and thus facilitates joining of the inner-tube extension 36 to the inner tube 31.

The upper end of the inner tube 31 includes a valve seat member 50. The valve seat member 50 has a fitting portion 51 positioned on the lower end, the fitting portion 51 being fitted into the outer circumference of the tube 32 positioned on the upper end of the inner tube 31. The valve seat member 50 includes a filter presser 52 extending circumferentially and larger in diameter than the fitting portion 51.

If the inner tube 31 is inserted into the cylinder 4a and thrust into the base 4 with the inner tube 31 being fitted to the cap 5, then the valve seat 50 tightly contacts the seal plate 28, and the filter element 3 is pushed in the axial direction of the cylinder 4a. As a result, the filter element 3 is held between the end surface of the fitting tube 8 and the filter presser 52 of the valve seat member 50, being positioned coaxially with the cylinder 4a. The inner circumferential side and the outer circumferential side of the filter element 3 are thereby liquid-tightly sealed from each other, thus separating the interior of the filter case 2 into a dirty side S1 and a clean side S2.

The valve seat member 50 includes a through-hole 53 at the center of the fitting portion 51. The valve seat member 50 includes a relief valve 55. The relief valve 55 is provided movably in the axial direction of the cylinder 4a. The relief valve 55 includes a valve 57 abuttable with the opening of the lower end of the through-hole 53. The relief valve 55 includes a valve support member 58 extending upward via the inner circumferential surface of the through-hole 53 of the valve member 50. The relief valve 55 includes pawl 59 formed on the distal end of the valve support member 58. The relief valve 55 includes coil spring 60 provided on the respective pawl 59 and on a spring shoe 54 provided on the upper end of the valve seat member 50. The coil spring 60 urges the valve 57 toward the opening of the lower end of the through-hole 53. If a pressure difference between the dirty side S1 and the clean side S2 is within a predetermined value, the through-hole 53 formed in the valve seat member 50 is closed by the valve 57. If a pressure of the clean side S2 rises to be equal to or higher than a predetermined value, the valve 57 separates from the valve seat member 50, thereby opening the through-hole 53. The opened through-hole 53 releases the pressure from the clean side S2 to the dirty side S1.

The upper end of the valve seat member 50 includes a support 67 that is engaged with the pawl 5a extending downwardly from the upper end of the cap 5. The support 67 urges the valve seat member 50 downwardly in the axial direction of the cylinder 4a using a coil spring 65. The support 67 includes an opening 67a formed on the side surface of the valve seat member 50. The opening 67a allows the oil flowing from the through-hole 53 formed in the valve seat member 50 to flow into the dirty side S1. The oil flowing from the clean side S2 into the dirty side S1 through the opening 67a returns again to the clean side S2 through the filter element 3.

In the oil filter 1 described above, the inner tube 31 and the inner-tube extension 36 are fitted into the cap 5, with the support 67, the relief valve 55, and the valve seat member 50 located in the cap 5. The inner tube 31 and the inner-tube extension 36 together with the filter element 3 are inserted into the base 4. Thereafter, the cap 5 is thrust into the base 4 until the flange 5c abuts against the cylinder 4a of the base 4. As a result, the oil filter 1 illustrated in FIG. 1 is completed.

In the assembly illustrated in FIG. 1, the inner-tube extension 36 inserted in the base 4 is forced into a deep side (lower side in FIG. 1) of the oil-feeder channel 16. As a result, the drain channel 17 is closed. As shown in FIG. 3A, the joint portion, having the inner-tube extension 36 and the inner tube 31 joined each other, is fitted into the fitting tube 8a. The inner tube 31 and the inner-tube extension 36 are positioned in the base 4 with a predetermined clearance S. At this time, the inner circumferential surface of the tube 33 on the lower end of the inner tube 31 slides on the sliding member 41 of the inner-tube extension 36. This sliding prevents an excessive load from being imposed on the inner tube 31. Furthermore, fastening of the cap 5 in the base 4 prevents a deformation or buckling caused by compression of the inner tube 31.

When the vehicle engine is started and the pressurized oil is introduced to the inlet port 12 in this state, the oil flows into the dirty side S1. The oil radially passes through the filter element 3 and flows into the clean side S2 through the clearances of the inner tube 31. Further, the oil is introduced to a predetermined lubrication position through the oil-feeder channel 16 and the outlet port 13. At this time, oil-caused pressure is applied to the lower end of the inner-tube extension 36, thereby pulling out the inner-tube extension 36 downward. On the other hand, as shown in FIG. 3A, the inner tube 31 and the inner-tube extension 36 are positioned below the joint portion, having the inner tube 31 and the inner-tube extension 36 joined each other, with a predetermined clearance S. The sliding member 41 of the inner-tube extension 36 slides downward with respect to the inner circumferential surface of the tube 33 provided on the lower end of the inner tube 31. Due to this, the engagement portion 37 of the inner-tube extension 36 abut against the stepped portion 9 as shown in FIG. 3B. At this moment, load is not imposed on the engagement portion 37.

When the engine is stopped and the pressure of the oil introduced into the inlet port 12 falls, the dirty side S1 and the clean side S2 enclose the oil therein. In this state, the cap 5 is loosened so as to remove the filter element 3. The support 67, the relief valve 55, the valve seat member 55, the inner tube 31, and the inner-tube extension 36 fitted to the cap 5 are separated from the base 4 to follow the loosening of the cap 5. Accordingly, the oil-feeder channel 16 communicates with the drain channel 17, thereby returning the oil contained in the base 4 to the oil pan of the engine.

After removing the cap 5, pulling of the filter element 3 off permits only the used filter element 3 to be disposed. A new filter element 3 is arranged in the base 4. The inner tube 31 and the inner-tube extension 36 fitted to the cap 5 are inserted into the inner circumferential side of the filter element 3 for assembly, thus fitting the cap 5 to the base 4.

The invention is not limited to the embodiment described above and is carried out in various manners. For example, the invention is not limited to the oil filter used in the vehicle engine but also applicable to various oil filters such as a working fluid filter used in an automatic transmission. The sliding member 41 is arranged on the inner circumference of the tube 33a. While, the sliding member 41 may be arranged on the outer circumference of the tube 33a. In this alternative, the pawl 42 on the distal end of the sliding member 41 is arranged to direct inward. In another alternative, the sliding member 41 may be provided in the inner-tube extension 36 and the tube 33 sliding on the sliding member 41 may be provided in the inner tube 31. In still another alternative, the sliding member 41 may be provided in the inner tube 31 and the tube 33 sliding on the sliding member 41 may be provided in the inner-tube extension 36. In this alternative, the members that function as stopper restricting movement of the tube 33 may be provided on the upper and lower both ends of the sliding member 41, respectively.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

What is claimed is:

1. An oil filter comprising:
a base having an inlet port, an outlet port, and an oil channel communicating with the outlet port;
a cap removably provided to the base, forming a filter case with the base; and
a tubular filter element contained within the filter case,
wherein the oil channel coincides with the filter element in axis and extends in an axial direction of the filter case,
wherein the oil filter includes an inner tube located in the filter element; and an inner-tube extension fitted to the inner tube, being movable in the axial direction of the filter case and being located on a side of the outlet port of the oil channel,
wherein the base includes a holding portion having a joint portion, having the inner tube and the inner-tube extension joined each other, fitted therein and holding the joint portion,
wherein the holding portion includes a clearance portion allowing the inner-tube extension to move in a direction of separating from the inner tube under a hydraulic pressure.

2. The oil filter according to claim 1,
wherein the joint portion includes a sliding portion extending from one of the inner tube and the inner-tube extension to the other one of the inner tube and the inner-tube extension in the axial direction; and a ring portion formed to the other one of the inner tube and the inner-tube extension and fitted in the sliding portion,
wherein both ends of the sliding member in the axial direction include stoppers to abut against the ring portion for restricting movement of the sliding portion.

3. The oil filter according to claim 2,
wherein the sliding portion is elastically deformable,
wherein the distal end of the sliding portion is displaceable radially of the ring portion relative to the proximal end of the sliding portion,
wherein the displacement of the distal end of the sliding member allows the inner tube and the inner-tube extension to be removed from each other.
